(19) United States
(12) Patent Application Publication
(10) Pub. No.: US 2002/0178242 A1
(43) Pub. Date: Nov. 28, 2002

(54) System, method, server, computer and computer program for activating a computer

(76) Inventor: Hideki Eda, Tokyo (JP)

Correspondence Address: McGinn & Gibb, PLLC, 8321 Old Courthouse Road, Suite 200, Vienna, VA, 22182-3817, US

(21) Appl. No.: 10/155,076

(22) Filed: May 28, 2002

(30) Foreign Application Priority Data
May 28, 2001 (JP) 2001-159468

(51) Int. Cl. G06F 15/16

(52) U.S. Cl. 709/222; 713/1

(57) ABSTRACT

A flash ROM stores an initial BIOS in a local computer. The initial BIOS is a program that the local computer needs at least for accessing a BIOS server. The server contains a subsequent BIOS. A processor of the local computer tries to access the server under the control of the initial BIOS, in a start-up process of the local computer. In the case where the accessing to the server is succeeded, the subsequent BIOS is transferred from the server to the local computer. The processor executes a process in accordance with the subsequent BIOS.

### BACKGROUND OF THE INVENTION

1. Field of the Invention

The present invention relates to a computer system, and, more particularly, to a start-up process of a computer system.

2. Description of the Related Art

A BIOS (Basic Input Output System) is a program responsible for a start-up process of computers. The BIOS also manages the data flow between operating systems and peripheral devices (e.g. a hard disk, a video adapter, a keyboard, a mouse, a printer, etc.). Under the control of the BIOS, the computer system can update information for setting the hardware.

Those instruction codes included in the BIOS are stored, for example, in a flash ROM (Read Only Memory) serving is a non-volatile memory. The CPU (Central Processing Unit) of the computer system initializes the hardware or manages the above-described data flow, in accordance with the instruction codes read out from the flash ROM.

In the case where new hardware is employed in a computer system, it is necessary to adjust the BIOS. In this case, for example, the BIOS may need to be updated, enhanced, corrected or the like. The adjustment of the BIOS means rewriting of the instruction codes stored in the flash ROM. If the computer system is disconnected from the power source while rewriting the BIOS, the BIOS may be deteriorated. In the worst case, the computer system can not be activated, because of the deterioration of the BIOS. The recovery of the BIOS requires a lot of work to be accomplished and takes much time. Thus, the possibility of the deterioration of the BIOS is preferably as low as possible.

Those procedures for rewriting the flash ROM are complicated. In the case where the flash ROM is rewritten, the computer system is set in the special operational environment. Hence, generally speaking, only those highly skilled in the art can adequately adjust the BIOS. In other words, the skill beyond that of general computer users is often required to adjust the BIOS. From this aspect, it is desired that the BIOS can easily be adjusted by the general computer users.

It is preferred that the start-up process of the computer system flexibly be customized, in the context that a wide variety of hardware devices are expanded. High flexibility of the start-up process causes an increase in the instruction codes of the BIOS. In contrast to this, due to the restrictions on the cost or size, the capacity of the flash ROM is limited. The instruction codes stored in a small capacity flash ROM can constitute simply an inflexible BIOS. It is demanded that a technique for enhancing the flexibility of the start-up process be developed, while still restricting the cost or size of the computer system.

Conventionally, the program serving as the BIOS is stored in the flash ROM that the computer system has. In such context, when adjusting the BIOS incorporated in each of a number of computer systems, the administrative operator of the computer systems needs to operate the computer systems one by one. Adjusting the BIOS requires a lot of work to be done and requires much time.

A technique for administering the BIOS is disclosed in each of Unexamined Japanese Patent Application KOKAI Publication No. H6-75755, Unexamined (Japanese Patent Application KOKAI Publication No. H8-69376, National Publication No. H11-1504459 and Unexamined Japanese Patent Application KOKAI Publication No. 2000-299579. Further, a technique for loading a program from a remote terminal to a server is disclosed in Unexamined Japanese Patent Application KOKAI Publication No. H11-53215. The entire contents of the publications are hereby incorporated by reference.

### SUMMARY OF THE INVENTION

The present invention has been made in consideration of the above. It is accordingly an object of the present invention to provide a system which can safely and easily adjust a BIOS.

Another object thereof is to provide a system which can execute a high flexible start-tip process.

In order to accomplish the above objects, according to the first aspect of the present invention, there is provided a system for activating a computer, comprising:

a server which includes a remote BIOS (Basic Input Output System); and

a local computer which can access the server through a network, and

wherein the local computer includes:

an interface which is connected to the network and receives the remote BIOS from the server; and

a processor which executes a start-up process of the local computer, in accordance with the remote BIOS received by the interface.

According to this invention, it is not necessary to adjust the BIOS in the local computer. The BIOS including a large number of instruction codes can be provided from the server to the local computer, and thus enhancing the flexibility of the start-up process. In the case where a plurality of local computers are installed, the BIOS included in the server is adjusted, thereby adjusting the BIOS of the entire local computers.

The local computer may include a non-volatile memory storing a local BIOS.

In this case, the processor may execute the start-up process of the local computer, in accordance with the local BIOS stored in the non-volatile memory, in a case where the processor can not access the server.

The remote BIOS included in the server may include a first program module for executing POST (Power On Self Test) and a second program module for enabling the first program module to be transferred from the server to the local computer; and

the processor which downloads the second program module from the server and may execute the downloaded module, to establish a communications link for downloading the first program module.

The processor may download a plurality of portions of the first program module sequentially one after another from the server, and execute the downloaded portions.

In order to accomplish the above objects, according to the second aspect of the present invention, there is provided a method of activating a computer, comprising

maintaining a first program module for executing POST (Power On Self Test) and a second program module for enabling the first program module to be transferred, in a server;

downloading the second program module from the server into at least one local computer;

executing the second program module, thereby transferring the first program module from the server into the at least one local computer; and

executing a start-up process of the at least one local computer in accordance with the first program module, in the at least one local computer.

The method may further comprise:

storing a third program module in the at least one local computer;

detecting whether the at least one local computer fails in accessing the server; and

executing a start-up process of the at least one local computer in accordance, with the third program module, in the at least one local computer.

In order to accomplish the above objects, according to the third aspect of the present invention, there is provided a server which is connected to at least one computer through a network, wherein

the server provides the at least one computer with a BIOS (Basic Input Output System) including a program module for executing POST (Power On Self Test), in a start-up process of the at least one computer.

In order to accomplish the above objects, according to the fourth aspect of the present invention. there is provided a computer which is connected to a server through a network, comprising:

an interface which is connected to the network and receives a remote BIOS from the server; and

a processor which executes a start-up process of the computer, in accordance with a remote BIOS received by the interface.

The computer may further comprise

a non-volatile memory which stores a local BIOS, and

wherein the processor executes a start-up process of the computer in accordance with the local BIOS stored in the non-volatile memory, in a case where the processor can not access the server.

In order to accomplish the above objects, according to the fifth aspect of the present invention, there is provided a computer program including instruction codes for:

maintaining a first program module for executing POST (Power On Self Test) and a second program module for enabling the first program module to be transferred, in a server;

downloading the second program module from the server into at least one local computer;

executing the second program module, thereby transferring the first program module from the server to the local computer; and

executing a start-up process of the at least one local computer in accordance with the first program module, in the local computer.

### BRIEF DESCRIPTION OF THE DRAWINGS

These objects and other objects and advantages of the present invention will become more apparent upon reading of the following detailed description and the accompanying drawings in which:

FIG. 1 is a diagram showing the structure of a system according to an embodiment of the present invention:

FIG. 2 is a diagram showing the structure of a local computer;

FIGS. 3A and 3B are diagrams showing a start-up process of the local computer.

### DETAILED DESCRIPTION OF THE PREFERRED EMBODIMENT

A preferred embodiment of the present invention will now be described with reference to the accompanying drawings.

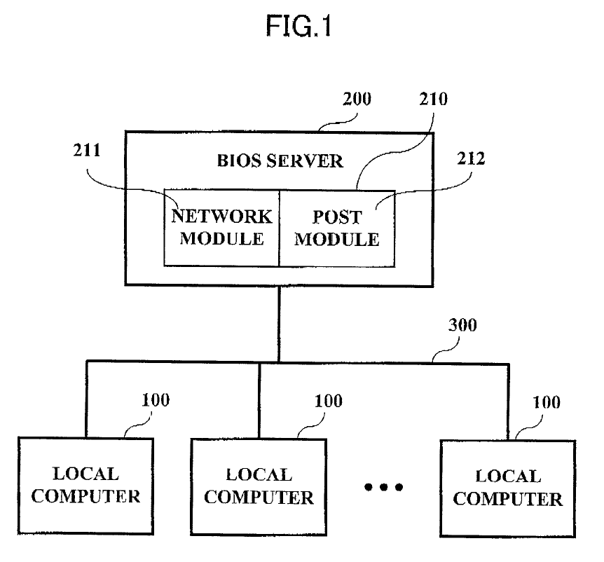

FIG. 1 is a diagram showing the structure of a system according to the embodiment of the present invention.

The system of this embodiment comprises a plurality of local computers 100, a BIOS server 200 and a network 300. The plurality of local computers 100 and the BIOS server 200 are connected with each other through the network 300.

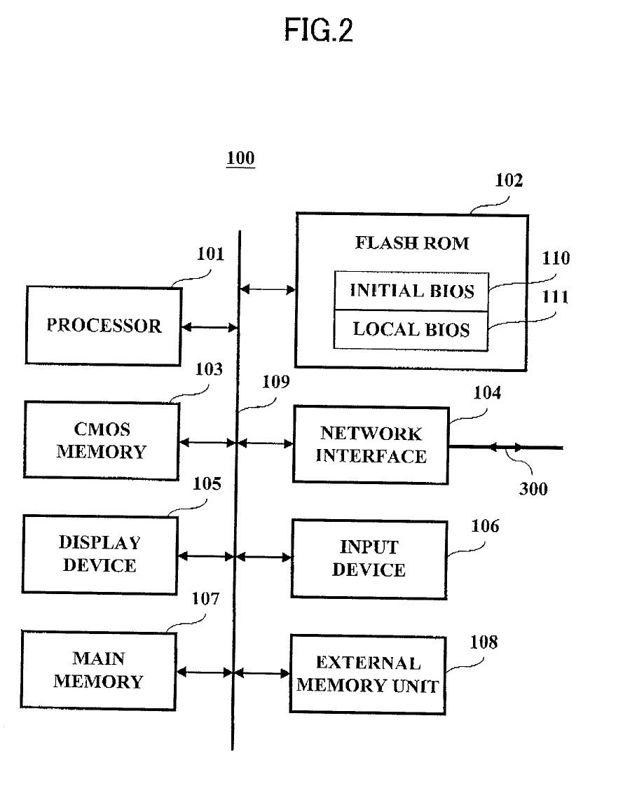

FIG. 2 is a diagram showing the structure of each of the plurality of local computers 100. As shown in FIG. 2, each of the plurality of local computers 100 comprises a processor 101, a flash ROM 102, a CMOS (Complementary Metal-Oxide Semiconductor) memory 103, a network interface 104, a display device 105, an input device 106, a main memory 107, an external memory unit 108 and a bus 109. In each of the plurality of local computers 100, the entire elemental components are connected with each other through the bus 109.

In each of the plurality of local computers 100, the processor 101 executes a start-up process of its local computer 100. The start-up process includes a first process corresponding to an initial BIOS 110 stored in the flash ROM 102 and a second process corresponding to a subsequent BIOS 210 downloaded from the BIOS server 200. In the case where the local computer 100 can not access the BIOS server 200, a third process corresponding to a local BIOS 111 stored it) the flash ROM 102 is executed instead of the second process.

The subsequent BIOS 210 downloaded from the BIOS server 200 includes a plurality of program modules. For example, the subsequent BIOS 210 includes a network module 211 and a POST module 212. The network module 211 is specially designed for the local computer 100 to download the POST module 212. The network module 211 controls a transmission/reception operation and an input/output operation of the local computer 100. The processor 101 executes the network module 211, thereby downloading the POST module 212 from the BIOS server 200.

The flash ROM 102 is a non-volatile memory storing the initial BIOS 110. The initial BIOS 110 is a program that the local computer 100 needs at least for accessing the BIOS server 200. The flash ROM 102 includes, for example, instruction codes for initially-setting each elemental component of the local computer 100, initializing the network interface 104, accessing the network 300, downloading the subsequent BIOS 210 and executing the subsequent BIOS 210.

The local BIOS 111 is stored in the flash ROM 102. The local BIOS 111 causes the local computer 100 to operate as a stand-alone computer, when the local computer 100 can not execute the subsequent BIOS 210. The capacity of the flash ROM 102 may be restricted to a minimum for storing the initial BIOS 110 and the local BIOS 111. According to this structure, the cost and size of the local computer 100 can be reduced.

The CMOS memory 103 is a nonvolatile memory. In other words, even when no power is supplied to the local computer 100, the data in the CMOS memory 103 does not get lost. The CMOS memory 103 stores configuration information with which the local computer 100 access the BIOS server 200 through the network 300. For example, the configuration information stored in the CMOS memory 103 includes a network address of the local computer 100 or security information, such as a password, etc.

The network interface 104 enables the local computer 100 to access the BIOS server 200 through the network 300. The network interface 104 performs communications with the BIOS server 200 through the network 300.

The display device 105 is, for example, a CRT (Cathode Ray Tube) display. The display device 105 displays messages related to the operations mode of the BIOS.

The input device 1106 includes, for example, a keyword, a mouse, etc.

The main memory 107 is, for example, a RAM (Random Access Memory) for providing a work area of the processor 101.

The external memory unit 108 is, for example, a hard disk drive (HDD). The operating system (OS) of the local computer 100 is stored in the external memory unit 108.

The BIOS server 200 shown in FIG. 1 is a computer system including a CPU, a semiconductor memory, a hard disk drive, and a network interface. The BIOS server 200 provides the plurality of local computers 100 with the subsequent BIOS 210, so that the start-up process of the plurality of local computers 100 can totally be managed. This start-up process includes POST (Power On Self Test) in the local computer 100. The BIOS server 200 has the subsequent BIOS 210 to be supplied to each of the plurality of local computers 100. For example, the subsequent BIOS 210 is stored in the hard disk drive included in the BIOS server 200.

The network 300 is a LAN (Local Area Network), a WAN (Wide Area Network), a TCP/IP (Transmission Control Protocol/Internet Protocol) network.

Operations of the system according to the embodiment of the present invention will now be explained.

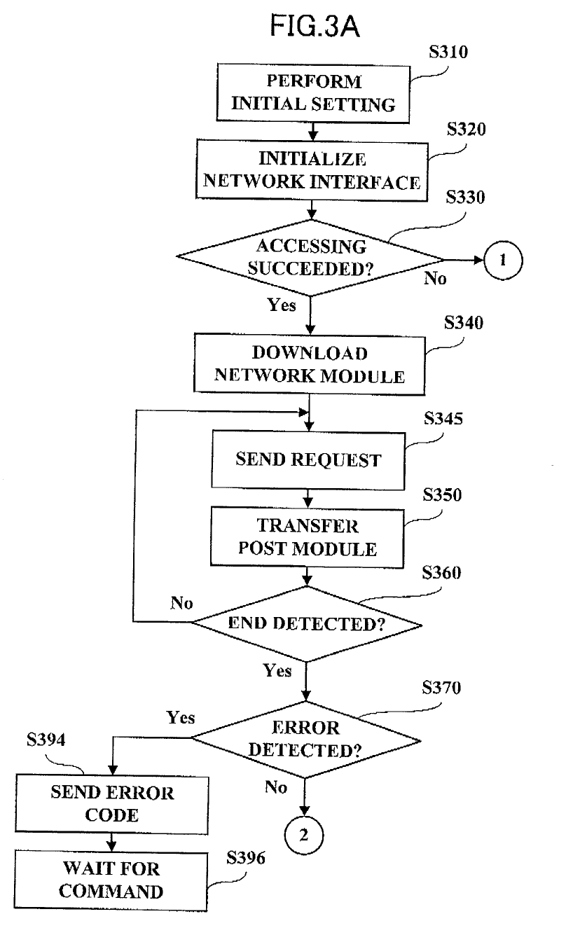

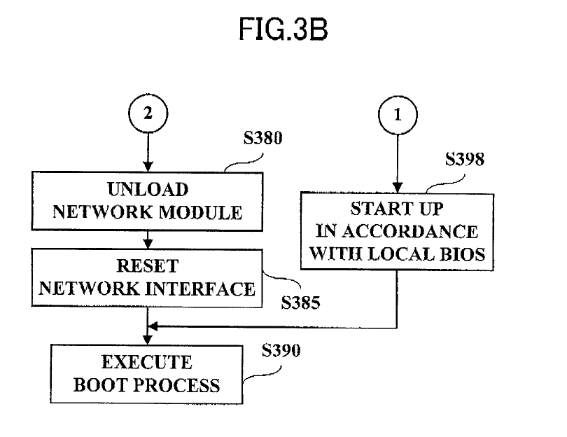

FIGS. 3A and 3B are flowcharts for explaining a start-up process of each of the plurality of local computers 100. Each of the plurality of local computers 100 begins the start-up process, upon application of power thereto.

If the start-up process begins, the processor 101 reads out instruction codes corresponding to the initial BIOS 110 stored in the flash ROM 102. The initial BIOS 110 performs initial setting of each of the elemental components of the local computer 100 (Step S310). In addition, the initial BIOS 110 initializes the network interface 104 (Step S320).

The processor 101 tries to access the BIOS server 200 using the network interface 104, under the control of the initial BIOS 110. When accessing the BIDS server 200, the processor 101 refers to the configuration information stored in the CMOS memory 103. At this time, the processor 101 determines whether accessing to the BIOS server 200 has been succeeded (Step S330).

In the case where the BIOS server 200 is not found on the network 300 or in the case where the communications link can no be established with the BIOS server 200, the local computer 100 can not access the BIOS server 200. In such context, the processor 101 reads out instruction codes corresponding to the local BIOS 111 stored in the flash ROM 102. The processor 101 executes a start-up process including a POST for checking the operations of each elemental component of the local computer 100 (Step S398).

In the case where the local computer 100 can access the BIOS server 200, the processor 101 downloads the subsequent BIOS 210 from the BIOS server 200 through the network 300, using the network interface 104. In more particular, the processor 101 downloads the network module 211 at first (Stop S340). The network module 211 implements a communications function suitable for downloading the POST module 212, in the local computer 100. The network module 211 establishes a communications link, which enables downloading of the POST module 212, between the local computer 100 and the BIOS server 200. The local computer 100 sends a request corresponding to the POST module 212 to the BIOS server 200, using the network module 211 (Step S345). In response to a request from the local computer 100, the BIOS server 200 transfers the POST module 212 to a corresponding one of the local computers 100 (Step S350). The processor 101 executes a POST task in accordance with the POST module 212 downloaded by the local computer 100.

The POST module 212 may include a plurality of portions. In this case, the plurality of portions of the POST module 212 include a task identifier representing the end of the POST task. The local computer 100 downloads each of the plurality of portions of the POST module 212 from the BIOS server 200 one after another, in accordance with the task identifier. The processor 101 detects the end of the POST task, based on the read result of the task identifier (Step S360). in the case where the end of the POST task can not be detected, the processor 101 sends a request for another portion of the POST module 212 to the BIOS server 20).

In response to this request from the local computer 100, the BIOS server 200 transfers one of the plurality of portions of the POST module 212 to the local computer 100. After one of the plurality of portions of the POST module 212 is downloaded by the local computer 100, a POST task corresponding to the downloaded portion by the processor 101 in the local computer 100.

In the case where the end of the POST task is detected, the processor 101 detects if there is an error occurring in the POST task (Step S370). In the case where the processor 101 detects an error in the POST task, an error code corresponding to the contents of the detected error is sent from the local computer 100 to the BIOS server 200 (Step S394). The processor 101 waits until a command regarding controlling of the error is sent from the BIOS server 200 (Step S396).

Upon reception of the error code from the local computer 100, the BIOS server 200 sends a command to a corresponding local computer 100, in accordance with the operation of the administrative operator of the BIOS server 200, In this case, the BIOS server 200 sends a command, For example, for resetting the local computer 100, experimentally loading the OS (Operating System), or activating a BIOS set-up program, to the local computer 100.

In the case where no error is detected in the POST task, the processor 101 unloads the network module 211 from the main memory 107 (Step S380).

Upon execution of the network module 211, the network interface 104 is in a special operational mode for downloading the POST module 212. To set the network interface 104 back into its initial state from tile special operational mode, the processor 101 resets the network interlace 104 (Step S385),

After this, to load the OS from the external memory unit 108 to the main memory 107, the processor 101 executes a boot process (Step S390).

The subsequent BIOS 210 is handled likewise any other general programs (e.g. application programs) in the BIOS server 200. For example, the subsequent BIOS 210 is stored in the hard disk drive included in the BIOS server 200. The subsequent BIOS 210 can safely be updated, without rewriting the information stored in the flash ROM 102.

In addition. even if the subsequent BIOS 210 is composed of a large number of instruction codes, it is not necessary that the flash ROM 102 have large capacity. The subsequent BIOS 210 is downloaded from the server 200, thereby the local computer 100 can execute various start-up processes. Further, the flash ROM 102 simply needs to store the initial BIOS 110 and the local BIOS 111, and hence realizing a small-sized local computer 100 at a low cost.

It is quite easy to adjust the BIOS of each of the plurality of local computers 100. For example, changing of the POST module 212 in the BIOS server 200 has an effect on the POST task in all of the plurality of local computers 100, The system administrator of the system of the present invention simply makes adjustment in the subsequent BIOS 210 in the BIOS server 200, so as to easily make adjustment in the BIOS of each of the plurality of local computers 100,

Various embodiments and changes may be made thereonto without departing from the broad spirit and scope of the invention. The above-described embodiment is intended to illustrate the present invention not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2001-159468 filed on May 28, 2001, and including specification, claims, drawings and summary. The disclosure of the above Japanese Patent Application is incorporated herein by reference in its entirety.

What is claimed is:

1. A system for activating a computer, comprising:
a server which includes a remote BIOS (Basic Input Output System); and
a local computer which can access said server through a network, and
wherein said local computer includes:
an interface which is connected to the network and receives said remote BIOS from said server; and
a processor which executes a start-up process or said local computer, in accordance with the remote BIOS received by said interface.

2. The system according to claim 1, wherein:
said local computer includes a non-volatile memory storing a local BIOS; and
said processor executes the start-up process of said local computer, in accordance with the local BIOS stored in said non-volatile memory, in a case where said processor can not access said server.

3. The system according to claim 1, wherein:
said remote BIOS included in said server includes a first program module for executing POST (Power On Self Test) and a second program module for enabling said first program module to be transferred from said server to said local computer; and
said processor which downloads said second program module from said server and executes the downloaded module, to establish a communications link for downloading the first program module.

4. The system according to claim 3, wherein
said processor downloads a plurality of portions of said first program module sequentially one after another from said server, and executes the downloaded portions.

5. A method of activating a computer, comprising
maintaining a first program module for executing POST (Power On Self Test) and a second program module for enabling said first program module to be transferred, in a server;
downloading said second program module from said server into at least one local computer;
executing said second program module, thereby transferring said first program module from said server into said at least one local computer; and
executing a start-up process of said at least one local computer in accordance with said first program module, in said at least one local computer.

6. The method according to claim 5, further comprising:
storing a third program module in said at least one local computer;
detecting whether said at least one local computer fails in accessing said server; and
executing a start-up process of said at least one local computer in accordance with said third program module, in said at least one local computer.

7. A server which is connected to at least one computer through a network, wherein
said server- provides said at least one computer with a BIOS (Basic Input Output System) including a program module for executing POST (Power On Self Test), in a start-up process of said at least one computer.

8. A computer which is connected to a server through a network, comprising:
an interface which is connected to said network and receives a remote BIOS from said server; and
a processor which executes a start-up process of said computer, in accordance with a remote BIOS received by said interface.

9. The computer according to claim 8, further comprising
a non-volatile memory which stores a local BIOS, and
wherein said processor executes a start-up process of said computer in accordance with the local BIOS stored in said non-volatile memory, in a case where said processor can not access said server.

10. A computer program including instruction codes for:
maintaining a first program module for executing POST (Power On Self Test) and a second program module for enabling said first program module to be transferred, in a server;
downloading said second program module from said server into at least one local computer;
executing said second program module, thereby transferring said first program module from said server to said local computer; and
executing a start-up process of said at least one local computer in accordance with said first program module, in said local computer.
